(19) United States
(12) Patent Application Publication
(10) Pub. No.: US 2025/0087039 A1
(43) Pub. Date: Mar. 13, 2025

(54) RENTAL GUEST GATE ACCESS SYSTEM AND METHOD

(71) Applicants: Jared Dworkin, Orlando, FL (US); Carlos Ricoveri, Orlando, FL (US)

(72) Inventors: Jared Dworkin, Orlando, FL (US); Carlos Ricoveri, Orlando, FL (US)

(21) Appl. No.: 18/824,378

(22) Filed: Sep. 4, 2024

Related U.S. Application Data
(60) Provisional application No. 63/537,002, filed on Sep. 7, 2023.

(51) Int. Cl. G07C 9/10; H04M 3/42; H04M 11/00

(52) U.S. Cl. CPC G07C 9/10; H04M 3/42059; H04M 11/007

(57) ABSTRACT

A rental guest gate access system includes a gate access system having a user interface device that selectively controls a barrier, a platform provider system and a property owner portal. The Platform Provider system obtains and assigns a telephone number to the property owner portal, and the gate access system associates the assigned telephone number to the property owner. A tenant accessing the gate access system will enter the rental unit information to cause the gate access system to call the assigned telephone number. The platform provider will answer the call and upon authentication of the caller id and the reservation system, will selectively provide an access code to the gate system to permit the tenant to enter the property.

### CROSS-REFERENCE TO RELATED APPLICATIONS

This application claims the benefit of U.S. Application Ser. No. 63/537,002 filed on Sep. 7, 2023, the contents of which are incorporated herein by reference.

### TECHNICAL FIELD

The present invention relates generally to the vacation rental industry, and more particularly to a system and method for authorizing and operating access gates for rental guests at residential property locations.

### BACKGROUND

The statements in this section merely provide background information related to the present disclosure and may not constitute prior art.

Vehicular access gates have long been used for private residences, apartments, and condo associations to prevent unauthorized access to properties. These systems are typically designed wherein a call box is located adjacent to the gate, and as a vehicle arrives the driver either enters their personal code or selects the residence they are visiting from the call box. Once selected, the system places an automated telephone call to the telephone at the residence in order to allow the residence to grant or deny access by entering their gate code. If access is denied the gate will remain closed. If access is granted, the gate will open to permit the vehicle to enter.

Although this system works well for units that are occupied, the system is not optimized for use with short term rental units. In recent years, there has been a drastic increase in the number of Property Owners who choose to rent their vacant properties as short term vacation rentals. Unfortunately, one of the most common complaints by renters of these units is their inability to enter the property due to the presence of an automated gate platform.

In this regard, the biggest issue is that the gate platform is unable to contact anyone to grant access to the renter when they initially arrive at the property. As a result, many owners have no choice but to provide their permanent gate code to the renters as a way to bypass the call feature of the gate platform. Although this does achieve the purpose of allowing the renter to enter the property, it introduces a long-term safety risk to the community, and completely defeats the overall purpose of the gate system itself.

Accordingly, it would be beneficial to provide a system and method for authorizing and operating access gates for renters at residential communities so as to overcome the issues noted above.

### SUMMARY OF THE INVENTION

The present invention is directed to a rental guest gate access system and method. One embodiment of the present invention can include a gate access system having a user interface device that selectively controls a barrier, a platform provider system, and a property owner portal. The Platform Provider system can be in communication with gate access system and the property owner portal.

In one embodiment, the platform provider can obtain a telephone number and assign the telephone number to the property owner portal. The property owner can update their contact information at the gate access system to utilize the assigned telephone number and provide the caller id for the gate access system telephone to the platform provider.

In one embodiment, a tenant can access the gate access system and enter the rental unit information. Upon receipt of the information, the gate access system can call the assigned telephone number which will be answered by the platform provider and upon authentication of the caller id and the reservation system selectively provide an access code to the gate system to permit the tenant to enter the property.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 shows an exemplary network environment of a rental guest gate access system according to some embodiments of the technology.

FIG. 2 shows an exemplary view of the gate access system, in accordance with one embodiment.

FIG. 3 shows an exemplary flow diagram illustrating a method for implementing a rental guest gate access system, according to one embodiment.

FIG. 4 shows an exemplary flow diagram illustrating a method of using the rental guest gate access system, according to one embodiment.

### DETAILED DESCRIPTION OF THE INVENTION

While the specification concludes with claims defining the features of the invention that are regarded as novel, it is believed that the invention will be better understood from consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

### Definitions

As described herein, the term “Community Association” can be the legal entity (and its representatives) for a particular housing community (e.g., condo, house, etc.) that is responsible for providing and/or operating an automated gate access system for the subject community.

The term “Property Owner” describes any individual, group or entity that owns, manages, or otherwise offers a unit within the subject community for rent to a guest.

The terms “renter,” “tenant” and “guest” are used interchangeably to describe any person who utilizes one or more aspects of the inventive system to rent and/or stay at a rental unit located in a community utilizing the inventive system.

The term “Platform Provider” describes the individual, group or legal entity that is overseeing the below described system in order to perform the methods described herein.

The term “telephone company” can include any individual, group or entity that provides communication services for use by the system components. More specifically, the company can establish telephone numbers and provide voice calling services for use in the manner described below.

In various embodiments, portions of the below described system can be performed on or can include the use of a website having any number of different URL addresses. In the preferred embodiment, the Platform Provider will operate the inventive system using the name GateTeck and can utilize a website having the same or similar name; however, other names and/or website URLs are also contemplated.

Additionally, it is contemplated that several different methods and/or method steps can be performed simultaneously via different websites that are directed towards different individual markets, and/or geographic locations. In this regard, use and/or operation of the system is not to be construed as limiting to a particular site. Such methods can be performed under the direct supervision of the original Platform Provider, or via secondary providers through a franchise or other agreement.

Although described throughout this document with regard to short term rentals of residential properties, this is for illustrative purposes only. As such, many other embodiments are contemplated wherein the system can be utilized for providing controlled access to automated gate and entry systems for any number of other industries and/or for any number of other purposes.

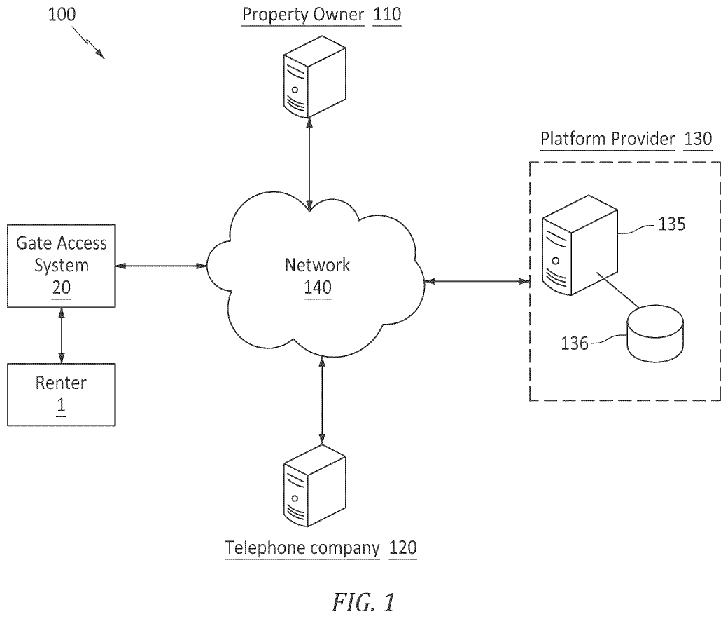

FIG. 1 is a block diagram of an example operating environment for the gate access and operation system on which the below described methodology may be implemented.

In one embodiment, the system 100 can include, for example, a community access gate system 20, having an interface device operated by a Renter 1, at least one Property Owner interface device 110 that is operated by a Property Owner, and a telephone systems interface device 120 that is operated by a communications platform that are connected to a Platform Provider 130 over a network 140.

As described herein, each of the one or more interface devices can be any form of computing device that can be operated by or controlled by a human user to perform the below described methodology. A computing device refers to any device with a processor and memory that can execute instructions and communicate with another device. Computing devices include, but are not limited to, any type of computers, smartphones and tablets and such devices may be purpose-built machines that are pre-encoded with an application interface, so as to perform the functionality so described.

In this regard, each of the computing devices can include functionality for downloading and running a mobile application and/or may include one or more client applications, such as a web browser, and application interface, for example, for communicating with the other interface devices and/or the Platform Provider 130 over the network 140.

As such, the system can function to generate a plurality of portals on which system Property Owners can send and receive information. Several nonlimiting examples of portals can include but are not limited to a registration portal for allowing Property Owners to provide details about their rental units including codes for instructing automated gate platforms to allow access to the property. Of course, any number of other portals may be provided for allowing communications between the Platform Provider and system users.

The Platform Provider 130, according to one embodiment, can include one or more individual computing devices 135 that can be connected to one or more databases 136 on which various portions of the method can be performed. The server 135 can function to provide a central hub for controlling the communication between the user interfaces through any number of different mediums such as the above noted website, for example. In this regard, one or more of the individual computing devices 135 can comprise a web server, an email server, an application database server and so forth, or the system can employ a single server device which functions to handle each of these processes.

In this regard, portions of the described methodology can be implemented as a computer program product, i.e., a computer program tangibly embodied in a non-transient machine-readable storage device, for execution by, or to control the operation of, a data processing apparatus. The computer program can be written in any form of computer or programming language, including source code, compiled code, interpreted code, scripting code (e.g., JavaScript) and/or machine code, and the computer program can be deployed in any form, including as a stand-alone program or as a subroutine, element, or other unit suitable for use in a computing environment.

The database 136 can function to receive and store information such as a Property Owner's account information, rental unit details, telephone numbers for the gate access systems for each of their units, subscription information and the like. As described herein, the database 136 can include any type of computer-readable storage mediums, including all forms of volatile and non-volatile memory such as, for example, semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks.

In addition, the devices can be operatively coupled to a communications network, such as network 140, to receive instructions and/or data from the network and/or to transfer instructions and/or data to the network. In one embodiment, the database or a portion thereof can include, comprise, or consist of blockchain technology for creating and storing information.

The network 140 is a communication network that that facilitates any form or medium or digital or analog communication such as a telephone network, a cellular network, a local area network (“LAN”), an intranet, a wide area network (“WAN”), the internet, and/or any other type of voice and/or data transmission and reception medium.

As will be described below, the system 100 provides a mechanism for allowing Property Owners to utilize a system-generated telephone number for use with the gate access system at a community in which they provide one or more rental units. When a tenant arrives at the property and accesses the gate system, the Platform Provider can authenticate the tenant and instruct the gate access system to permit the tenant to enter.

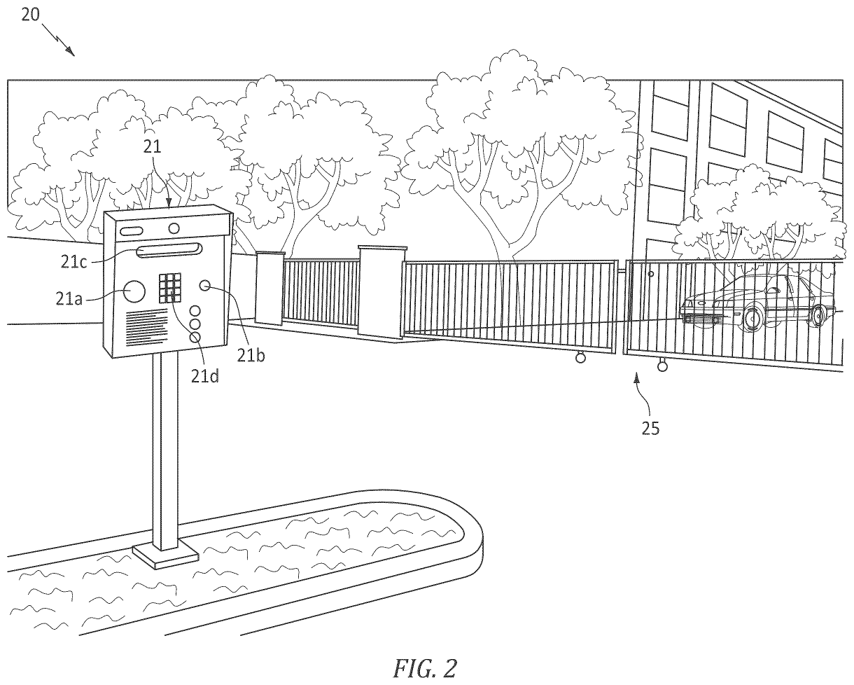

FIG. 2 illustrates one embodiment of a gate access system 20 for use with the system 100. As shown, the system 20 can include a user interface device 21 that is connected to an access barrier 25 such as a sliding fence or swing gate, for example.

In the present embodiment, the interface device 21 can include a two-way communications panel having a speaker 21a, microphone 21b, display screen 21c and touchpad 21d. The device can include a transceiver such as a telephone, cellular or internet-based modem, for example, which can be connected to a communications network such as network 140, for example. The interface 21 is connected to the access barrier 25 and selectively opens the same upon receipt of a valid access code via the keypad or upon receipt of a valid access code received from an external device over the network.

Although described above as interfacing with an existing community gate system 20, other embodiments are contemplated wherein the entire community gate system or the interface device 21 can be provided by the Platform Provider so as to include the hereinafter described functionality from the time of initial installation.

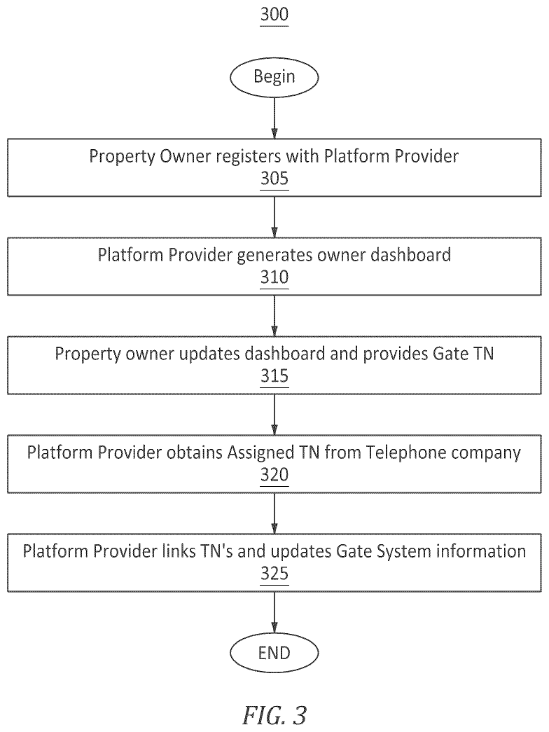

A method 300 for implementing the rental guest gate access system will now be described with respect to FIG. 3. Although described below with respect to particular steps, this is for illustrative purposes only, as the methodology described herein can be performed in a different order than shown and/or can include any number of other steps.

As shown at FIG. 3, the method can begin at step 305 wherein the Property Owner can register an account with the Platform Provider. This process may include providing information about the Property Owner (e.g., name, contact details, etc.), agreeing to a service plan, attending to payment obligations for accessing the Platform Provider system and the like.

Upon completion of the registration process, the method can move to step 310 where the Platform Provider can generate a Property Owner dashboard for access by the Property Owner interface device. As described herein, the owner dashboard can include any number of different interface pages for allowing the Property Owner to manage their listed unit(s) within the system.

At step 315, the Property Owner can update their owner dashboard with information about one or more of their rental properties. This information can include, for example, details about the rental unit and the telephone number used by the automated gate system(s) (e.g., “Gate TN”) at the property where the unit is located, along with the access code required to instruct the system to open the gate. Other information includes contact details for the residential community association (Homeowners or condo) to which the unit is located and/or the administrator who is responsible for programming the gate system and updating contact information for the same.

In addition to the above, the dashboard may provide options for allowing Property Owners to provide one or more default or customized messages to their rental guests when they access the gate system.

Next, the method can proceed to step 320, where the Platform Provider can obtain a new telephone number from a telephone company and assign the telephone number to the Property Owner's account (e.g., “Assigned TN”). Once created, the Platform Provider will automatically attend to the billing requirements for maintaining the Assigned TN through the subscription fees paid by the Property Owner for so long as the account remains active.

Finally, the method can proceed to step 325 where the Platform Provider can link the Assigned TN to the owner's account in the system database and instruct the Gate Access System 20 to update the contact information for the Property Owners unit to utilize the new Assigned TN going forward. In this regard, the Platform Provider may send an email request directly to the gate system administrator or request the Property Owner contact the gate system administrator to update the call list of the system 20 with the Property Owners newly Assigned TN.

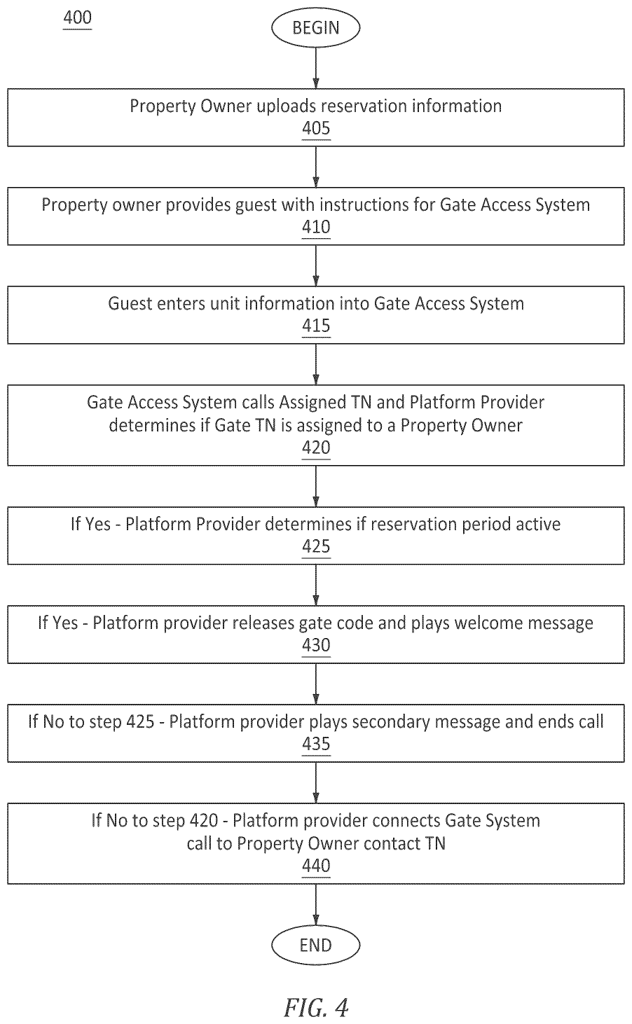

A method 400 for utilizing the rental guest gate access system will now be described with respect to FIG. 4. Although described below with respect to particular steps, this is for illustrative purposes only, as the methodology described herein can be performed in a different order than shown and/or can include any number of other steps.

The method can begin at step 405, where the Property Owner can upload reservation information for their unit into their dashboard. The information can include the dates the unit is to be rented along with the respective check-in and check-out times (e.g., active reservation period).

At step 410, the Property Owner can provide the guest with instructions for accessing the automated gate system 20 upon arrival at the property during their active reservation period. This may include instructions to select a particular name or unit number from the interface device 21 of gate system screen.

At step 415, the guest can arrive at the rental community and enter the name or unit they are renting on the interface device of the Gate Access System.

Upon entry of the same, the method can proceed to step 420 where the Gate Access system can call the Assigned TN which will be answered by the Platform Provider system. Upon answering the call, the Platform Provider will utilize caller id to determine if the Gate TN is associated with an active Property Owner account at step 420.

If the Gate TN is associated with an active Property Owner account, the Platform Provider will retrieve the reservation information for the respective account to determine if the call has occurred during an active rental period and whether a custom greeting or other message is to be provided at step 425.

For example, if the rental period is active, the Platform Provider can play a first audible message over the interface speaker such as “Welcome to Legacy Dunes, ‘guest name,’ we hope you enjoy your stay,” before providing the access code to open the gate at step 430.

Alternatively, if the rental period is not yet active, the Platform Provider can play a second audible message over the interface speaker such as “We are sorry, but your unit is not yet ready, please check back after 4 pm,” before disconnecting the call without providing the access code, at step 435.

Finally, if the rental period has expired, or is not listed in the system, the method can proceed to step 440 where the Platform Provider can either disconnect the call without providing the code, or connect the call from the gate interface directly to the Property Owners contact telephone number to allow the guest to speak with the Property Owner directly. In such an instance, the Property Owner may provide the access code or deny the same depending on the circumstance.

As to a further description of the manner and use of the present invention, the same should be apparent from the above description. Accordingly, no further discussion relating to the manner of usage and operation will be provided.

As described herein, one or more elements of the device 100 system components can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the term “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A rental guest gate access system, comprising:
a gate access system that is configured to selectively allow access to a community in which a rental unit is located;
a property owner portal that includes information about the rental unit and a property owner of the rental unit; and
a platform provider system that is in communication with each of the property owner portal and the gate access system,
wherein the platform provider includes functionality for receiving an access request by a tenant utilizing the gate access system,
wherein the platform provider includes functionality for authenticating the access request, and
wherein the gate access system includes functionality for permitting access to the community upon successful authentication by the platform provider.

2. The system of claim 1, wherein the gate access system comprises:
a user interface device that is configured to communicate over a network; and
a barrier that is selectively moved to permit access to the community.

3. The system of claim 1, wherein the platform provider includes functionality for obtaining a telephone number from a telephone company and for assigning the telephone number to the property owner portal.

4. The system of claim 3, wherein the gate access system is configured to call the assigned telephone number to communicate the access request.

5. The system of claim 4, wherein the platform provider is configured to answer the call using the assigned telephone number.

6. The system of claim 5, wherein said authentication includes determining if a caller identification of the call from the gate access system is associated with the property owner portal.

7. The system of claim 6, wherein said authentication further includes determining if the call is received during an active reservation period.

8. A method, comprising:
providing a property owner portal that includes information about a rental unit and a property owner of the rental unit;
providing a platform provider system that is in communication with each of the property owner portal and a gate access system located at a community in which the rental unit is located;
associating a caller identification of the gate access system with the property owner portal;
obtaining a telephone number from a telephone company;
assigning the telephone number to the property owner portal;
instructing the gate access system to contact the assigned telephone number;
receiving a call from a tenant utilizing the gate access system, said call being routed to the assigned telephone number;
determining the caller identification from the received call is associated with the property owner portal; and
providing an access code to the gate access system to permit entry of the tenant to the community.
